(19) United States
(12) Patent Application Publication
(10) Pub. No.: US 2006/0039566 A1
(43) Pub. Date: Feb. 23, 2006

(54) System for installing software with encrypted client-server communication

(75) Inventors: Daniel J. Stark, Webster, NY (US); Daniel A. Coccia, Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/921,566

(22) Filed: Aug. 19, 2004

(51) Int. Cl. H04L 9/00

(52) U.S. Cl. 380/278

(57) ABSTRACT

When client-server software is distributed from a vendor over a network, the server receiving the software generates a random encryption key in response to installing a part of the software. The encryption key is used for communication between the server and the client. Every installation of the software thus results in an effectively unique encryption, and no evidence of the encryption key is in the original client-server software.

### TECHNICAL FIELD

The present disclosure relates to a system for distributing and installing client-server software.

### BACKGROUND

Electronic or internet-based distribution of software packages is now commonplace. In brief, a customer who wants software installed on his computer can contact a software vendor's computer through the internet and receive an executable which causes the desired software to be installed on the customer's computer.

A practical challenge arises when the software obtained from the vendor includes “server” and “client” components. In such a case, the overall software package is installed on an initial customer computer which acts as a “server.” However, the customer may have further computers which he wishes to use as client computers with respect to the customer's “server” computer. Thus, portions of the software from the vendor must be further distributed to the customer's client computers.

If it is desired to establish secure communication between the client and server computers, a known approach is to provide secure-key encryption for at least some data transfers between the client and server computers. In the known prior art, however, these secure keys—strings of data used for data encryption—are included in the original software package sent from the vendor to the customer's computer. As such, the original software package can conceivably be analyzed by a hostile party, to enable access to communications between the client and server computers wherever the software is installed.

### PRIOR ART

U.S. Pat. No. 6,169,805 discloses a system by which encryption keys are distributed to selected users over the internet, to enable secure communication over a public network.

US Published Patent Application 2004/0010700-A1 describes a method by which software code being validated is tested for authenticity by attempting to decrypt a small portion of the code.

US Published Patent Application 2004/0029566-A1 discloses a system by which encryption keys are distributed to selected users, to enable secure financial transactions.

### SUMMARY

According to one aspect, there is provided a method of installing a software package, the software package including a server component and a client component. The server component is sent to a first computer. In response to receiving a portion of the software package, the first computer causes an encryption key to be generated. The encryption key is used for communication between the first computer and a second computer.

According to another aspect, there is provided a software package, suitable for downloading from a vendor computer, comprising a server component and a client component. Code within the package causes an encryption key to be generated as a result of the server component being installed on a first computer, the encryption key being useful in communication between the first computer and a second computer on which the client component is installed.

### BRIEF DESCRIPTION OF THE DRAWING

FIG. 1 is a diagram showing a method of installing client-server software.

### DETAILED DESCRIPTION

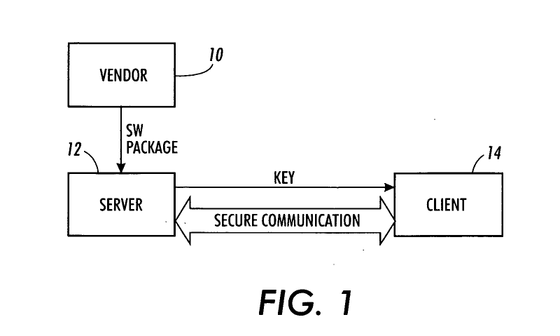

FIG. 1 is a diagram showing a method of installing client-server software. As shown, there is a “vendor” controlling a computer 10, a “server” computer 12, and a “client” computer 14. In this discussion, the computers or equivalent devices (such as digital printers) will be referred to by terms applied interchangeably to both the computer itself and the person or entity controlling the computer; e.g., the term “vendor” can refer either to a computer or to the entity controlling the computer. Also, each term “vendor,” “server,” and “client” shall be construed broadly, mainly to distinguish one computer (or method of using a computer) from another within the description.

In the present scenario, a server 12 desires to obtain a certain software package from vendor 10. The vendor 10 sends an executable to server 12 which initiates installation of the package, or a portion thereof, in a generally known manner. The software package includes what can be called a server component, which runs on server 12, and also a client component which runs on client 14, with secure communication between server 12 and client 14 being enabled by means within the software package. In one possible context, the server component on server 12 is a web-based program for accessing usage and other data from a client 14, which can be resident on a printer or a multi-function printing apparatus, in which case the client software is a user-interface-based package running on the printer. Vendor 10 must send the desired server component to server 12 and the client component to client 14: in one possible embodiment, both components are sent to server 12 and the client component is then sent from server 12 to client 14.

In the desired final state, there is a degree of secure communication between server 12 and client 14 when the software package from vendor 10 is in use. (There may of course be plural clients 14 communicating with server 12 at various times.) To enable such secure communication, there is provided an encryption system by which the server 12 and client 14 use secure-key encryption. As is generally known, in secure-key encryption two communicating parties each have a key, in the form of a data string, by which incoming encrypted data can be decrypted. The same or a different key can be used to encrypt data as it goes to the other party. Many variations of this type of encryption, such as “Pretty Good Privacy” or PGP, are available. In the present case, both the server 12 and the client 14 require a key for secure communication.

In this embodiment, a “key file” is generated by server 12 when a portion of the software package is installed on server 12. The key file contains (1) the dns name of the computer that it is running on (server 12); (2) the communication port that will be used for communication to client 14; and (3) the symmetric encryption key. In one embodiment, the secure key is generated by a Microsoft®.NET System.Security.Cryptography namespace resident on server 12, in response to the opening of a “server process” file during installation of the software package on server 12. The “server process” file, or equivalent thereof, is a file which, in use, in effect “listens” for a communication from the client 14. In one embodiment, the functionality of generating the key file originates in the software package sent to server 12 and resides in the code of the server process, which calls API's to generate the keys. The secure key is then embedded in the software installer of the client package which is then installed to client 14 and subsequently used for certain communications between server 12 and client 14, as will be explained below.

In this embodiment, the secure key is generated by server 12 at installation and communicated only to one or more client computers 14. The vendor 10 never receives or has access to the secure key, and the secure key is not present in any way in the original software package from the vendor 10. As such, the software package cannot be hacked to obtain a secure key, and the secure key is useful only between a specific server 14 and its declared clients such as 14: in other words, every time the software package is installed on a server 14 anywhere in the world, an effectively unique secure key is created between that server and its clients. In one embodiment, the secure key set up and used between a server 14 and client 14 can stay in effect essentially forever; a new key need not be re-generated on a session basis.

In one embodiment, only one set of data is encrypted using the generated encryption key: a “connection string” comprising a user name and password. The connection string is used for the server 12 to access a database within client 14 (or vice-versa). Once reasonably secure access to the database is established using the encrypted connection string, the database is accessed as needed using the password protection only. Under present practical conditions, this arrangement provides a suitable balance of security and performance. It is, of course, possible to provide for encryption of all data passing between server 12 and client 14.

In an alternate embodiment, a system can be provided that overrides an original secure key that is already specified in the software package, i.e., upon installation, instead of using the pre-loaded secure key, a new one is generated. Such an arrangement would protect against hacking of a legacy software package in which the security the original encryption key may have been compromised. In such a case, securely transmitting the newly-generated encryption key to the clients that need the key must be taken into account.

In one context, where server 12 operates a web-based program for managing printer functions, and each of several clients 14 operate user-interface-based control systems for individual printers or multifunction devices, the database includes data relating to print counts, paper supplies and printer capabilities.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method of installing a software package, the software package including a server component and a client component, comprising:
sending the server component to a first computer;
in response to receiving a portion of the software package, the first computer causing to be generated an encryption key; and
using the encryption key for communication between the first computer and a second computer.

2. The method of claim 1, further comprising
sending the client component to the second computer.

3. The method of claim 2, further comprising
the first computer sending the client component to the second computer.

4. The method of claim 1, the using step including encrypting a connection string for accessing a database within one of the first computer and the second computer.

5. The method of claim 1, the using step including encrypting a connection string for accessing a database within one of the first computer and the second computer, and not encrypting the database.

6. The method of claim 1, the first computer causing to be generated an encryption key in response to opening a server process file within the server component.

7. The method of claim 1, a vendor computer sending the server component to the first computer.

8. The method of claim 7, the vendor computer not having access to the encryption key.

9. The method of claim 7, wherein there is provided an original encryption key, and the first computer generates an encryption key which is used instead of the original encryption key.

10. The method of claim 1, the first computer operating a program for managing printer functions.

11. The method of claim 10, the second computer operating a user-interface-based control system for a digital printing apparatus.

12. The method of claim 10, the encryption key governing access to data relating to at least one of print counts, paper supplies and printer capabilities.

13. A software package, suitable for downloading from a vendor computer, comprising:
a server component;
a client component;
code for causing an encryption key to be generated as a result of the server component being installed on a first computer, the encryption key being useful in communication between the first computer and a second computer on which the client component is installed.

14. The package of claim 13, the code causing the first computer to generate an encryption key in response to opening a server process file within the server component.

15. The package of claim 13, the server component relating to operating a program for managing printer functions.

16. The package of claim 15, the client component relating to operating a control system for a digital printing apparatus.

17. The package of claim 15, the encryption key governing access to data relating to at least one of print counts, paper supplies and printer capabilities.
